(19) United States
(12) Patent Application Publication
(10) Pub. No.: US 2011/0287401 A1
(43) Pub. Date: Nov. 24, 2011

(54) ASSISTED PERFORMANCE AND LEARNING SYSTEM FOR STRING INSTRUMENTS (APLSSI)

(76) Inventor: Americo SALAS PERALTA, Cusco (PE)

(21) Appl. No.: 12/782,827

(22) Filed: May 19, 2010

(51) Int. Cl. G09B 7/00

(52) U.S. Cl. 434/362

(57) ABSTRACT

A method for allowing a user with no musical experience or training to play a musical piece with any string instrument of his/her choice, directly and immediately, guided by a computer the system and a set of visual light signals.

### FIELD OF THE INVENTION

This invention relates to the areas of entertainment and education, in the field of music and string instruments, used for its execution or learning.

### BACKGROUND OF THE INVENTION

There are programs leading the performer on how to play the notes corresponding to a musical piece pre-recorded in the digital memory of some electronic keyboard instruments. Specifically the electronic instruments called electronic organs, which as a demonstration, show how to follow the execution of these musical pieces pre-recorded on the equipment, usually accompanied by a percussion rhythm, also pre-recorded, and selected by the user. These cases are limited to these keyboard instruments and pursue no other goal than to demonstrate the qualities of an instrument to promote its sale. The full use of the instrument requires that the user must comply with the corresponding learning process about its execution, using a trained professional, a teacher or a method to follow.

There are also systems that allow playing a string instrument accompanied by other instruments for a selected song, but they imply a prior personal player's knowledge to accompany the song, not having, as in the case of APLSSI, an automatic guide, built-in on the instrument.

There are also methods of learning how to play the guitar on the internet, which are only learning or teaching methods using the computer showing the chords or notes on the screen.

Virtual guitars offer images of the neck of a guitar on the computer screen, being able to see and hear the notes by pressing the keyboard or mouse, simulating a real guitar.

### SUMMARY

The present invention allows a user with no musical experience or training to play a musical piece with any string instrument of his/her choice, directly and immediately, guided by the system, accompanied by other instruments of the chosen piece, including the case, that such a piece has a vocal component or singer.

The system also facilitates the learning of the execution of a string instrument following an academic approach, guided by the same instrument, providing the user with all the necessary steps to acquire the knowledge and expertise required, in order to become a solvent performer in a direct and brief manner, through successive practice.

APLSSI achieves the proposed objective of direct execution of musical pieces or learning its execution by using a real instrument, adapted to guide the user through an array of LEDs or lamps mounted on the neck. They will illuminate at the exact moment and exact position when each string must be pressed. For this, following the system's instructions makes the instrument to perform in a selected musical piece to be annulled and replaced by signals from the LEDs, while all other instruments integrated on such musical piece, including voices, will be listened normally and in parallel.

### BRIEF DESCRIPTION OF THE FIGURES

FIG. 1 illustrates an array of coordinates, fret and string;

FIG. 2 illustrates an equivalence of standard MIDI notes;

FIG. 3 illustrates a diagram of a MIDI system with master and secondary microcontrollers;

FIG. 4 illustrates a pulse train of the asynchronous serial communication;

FIG. 5 illustrates a circuit of insulation and protection;

FIG. 6 illustrates a DB15 Port;

FIG. 7 illustrates a power amp;

FIG. 8 illustrates a complete circuit;

FIG. 9 illustrates a diagram of the circuit board; and

FIG. 10 illustrates the location of the components.

### DETAILED DESCRIPTION OF THE INVENTION

APLSSI is a system whose objective is that a person without prior musical knowledge, that is, who does not know how to play a string instrument, is able to play musical pieces, while accompanied by the sound of other instruments incorporated in the composition of such musical pieces. The performer will also be able to play a string instrument of his/her choice when there are vocals, that is, when it is sung; or will be guided through the learning process of the instrument's execution by the same instrument. Therefore, the system offers three modes or objectives for the execution of string instruments: First, to play a selected instrumental musical piece directly, second, when the selected musical piece has vocals and third, if the system is used for learning the execution of the instrument. All proposed modes are achieved using a real string instrument adapted for such purpose.

For the first objective, the user must access a musical database using the Internet to select the musical piece of choice, configuring it according to the instructions of the system and obtain a string instrument to play, which will be annulled or substituted by the visual guide, that the APLSSI's prepared instrument will provide in order to play the selected piece. If the selected musical piece has vocals, that is, the second mode, the same effect will be obtained, following the system's instructions. For the third mode, there are predetermined files available online, including all the steps that the user must follow to learn to play the string instrument guided by it, following the steps indicated in the system. This learning or playing method of string instruments is unprecedented. The user can record a file of favorite songs on his/her own PC, after configuring according to APLSSI's instructions.

To play an instrumental musical piece or follow a playing learning method of string instruments, the instructions described in Annex 1 will be followed. To play a musical piece with voice, the instructions described in Annex 2 will be followed. For the playing learning method of instruments, it is easily possible to upload online playing learning methods of instruments, accessible to users, including established academic steps.

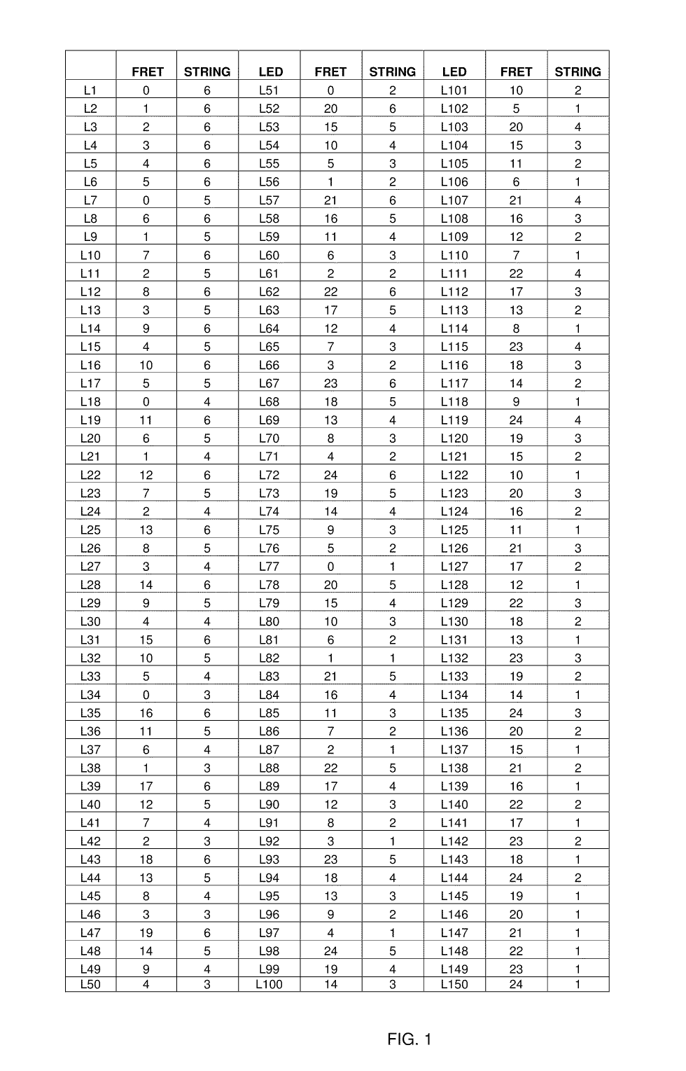

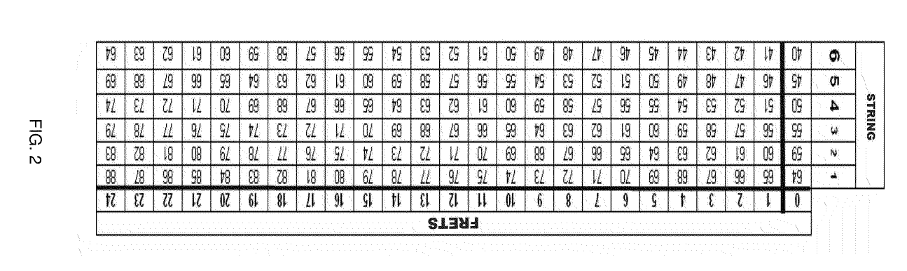

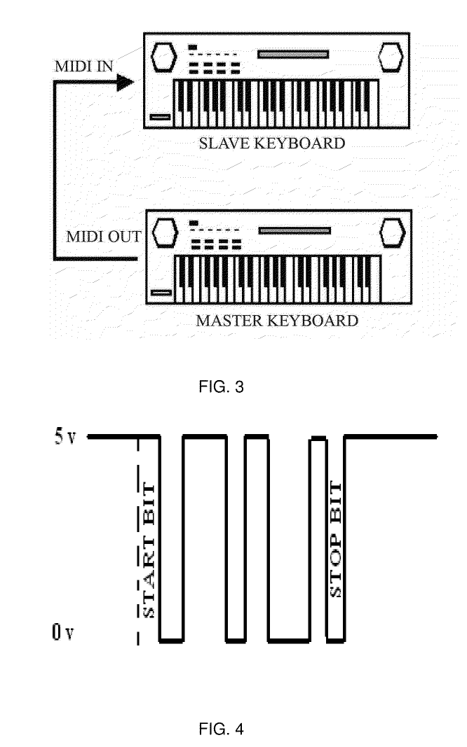

To explain how the system meets the proposed objective, we will choose the guitar as an example. This instrument usually has twenty-four sections in the neck called frets and six strings. There will be, including free strings to press, one hundred fifty options to press as total. Such number coincides with the number of LEDs (LED: Light-Emitting Diode) built-in on the neck of APLSSI's instrument, which will illuminate at the exact moment and location when the string must be pressed, according to the performing musical piece, along with the coordinating matrix of the fret and string, see FIG. 1. An equivalency table of standard notes of MIDI format is shown below; see FIG. 2.

The system requires a computer (PC or laptop with speakers, its output can be redirected to high power components of the user's choice) and one instrument prepared for such effect. Having this, the user will enter a musical database through the computer and select a piece to perform. By implementing the APLSSI's installation sequence, the system will recognize the musical piece and arrange it for execution on the prepared instrument. This means that the sound of the notes corresponding to this instrument will be annulled and substituted by light signals displayed on the neck. They will illuminate on the exact moment and point where they should be pressed, with the sound of the remaining instruments. Part of the performance of the musical piece will be heard as part of the accompaniment of it. This effect is provided on the system, even if the musical piece has vocals or is sung.

To achieve the described outcome, the system includes a software and hardware especially prepared for this case.

The software has two main components: the first, a software downloaded in the main microcontroller called master and the other component, a software included on the secondary microcontroller called slave. The main microcontroller decodes PC signals and illuminates the LEDs corresponding to the note being played. However, one microcontroller is not enough to control the quantity of existent notes. Those which are not found in its range, are sent to the secondary microcontroller (FIG. 3).

MIDI (Musical Instrument Digital Interface) is a data communication protocol between electronic musical instruments and other equipment, as the computer. A MIDI controller is a device capable of generating MIDI codes. A controller arrangement does not generate sound, just digital information or MIDI messages. The controller element is called master and the controlled element is called slave.

APLSSI's system needs a MIDI controller to operate the computer, which performs this task through software in charge of generating MIDI signs to be decoded. To explain the operation of the system, software was selected from all offered in the market, eventually freely distributed online, called “Cakewalk Guitar Studio,” which delivers MIDI signs through the computer's game port. This port is located in the audio cards, as a female connector DB15. The system is connected to this port, requiring a 7 volts DC supply.

The files to be played in this program are MIDI files with extension “MID” and will be available online free, eventually. In Annex 1, there is a user's manual as well as the installation file of “Cakewalk” software. In Annex 2, there is a user's manual if the musical piece includes voice.

There is a MIDI controller program as a software component to be used; in this case “Cakewalk” and the other software components are the programs that are included on each of the microcontrollers. A “C language” compiler was used, which can operate with Mplab (a set of integrated tools to develop applications using microcontrollers) of Microchip.

The master microcontroller decodes the PC signals and illuminates the LEDs corresponding to the note being played. However, one microcontroller is not enough for so many notes, therefore, those not in its domain are delegated to the slave microcontroller.

The program for the master microcontroller is in Annex 3.

The program for the slave microcontroller is in Annex 4.

The master manages the notes 40 to 62 and the slave 63 to 87 notes and you can see the equivalence in FIG. 2.

The hardware consists of two cards, the first includes the LEDs array indicating the position when they are illuminated and how long a note should be played and the second card includes the “brain of the system”, as well as the power amp. For example, the “brain of the system” includes a microcontroller PIC 16f877 from the company Microchip, in collaboration with another identical microcontroller, configured as slave, manages the array of LEDs.

It uses two microcontrollers due to the high register of notes that a guitar has. For example, the microcontrollers mentioned,—were selected due to the low cost, the possibility to establish a serial communication with the computer, number of ports, practicality and does not require too many components for its operation and, above all, the MIDI protocol transmits asynchronous serial data at a speed of 31.25 Kbps (Kilo baud per second), so it requires a 20 MHz crystal to generate clock pulses for each microcontroller (FIG. 4).

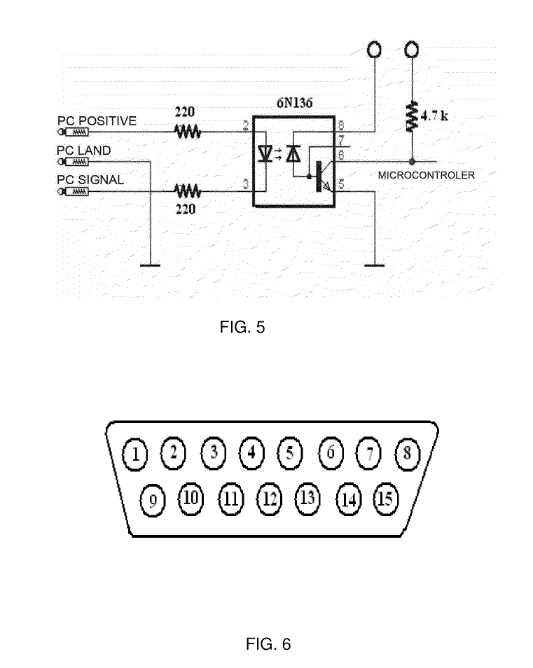

The connection cables coming from the PC must be isolated to avoid damage to the computer's port; this protection is performed by the integrated circuit 6H135 or 6N136, an opto-isolator (FIG. 5).

The cable that connects the PC to the system only uses a three-pin DB15 port:

Pin 1, 8 or 9: Positive (5 v), pin 4 or 5: Negative or ground and pin 12: Signal (MIDI out) (FIG. 6).

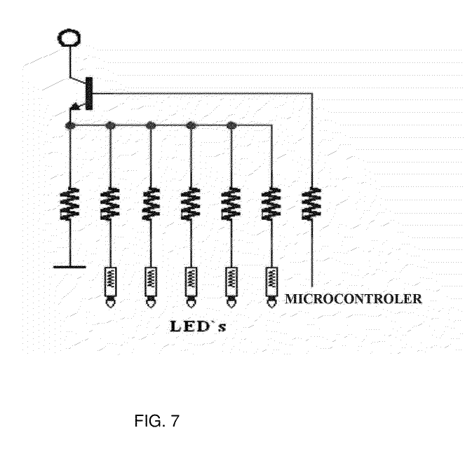

Transistors are used to amplify the current coming from the microcontroller to feed in some cases up to six LEDs. This forms the power amplifier (FIG. 7).

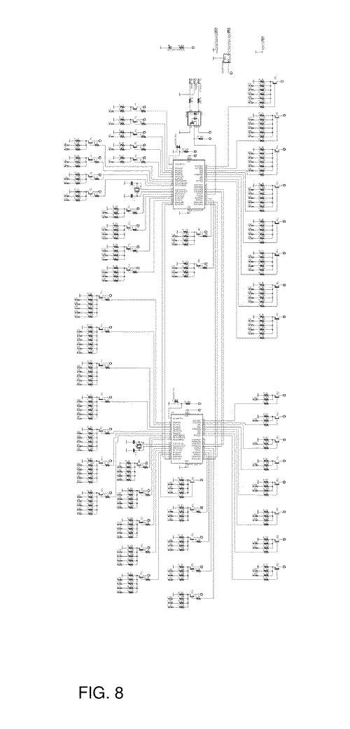

The entire circuit is shown in FIG. 8. A detailed enlargement of the complete circuit is shown in Annex 5.

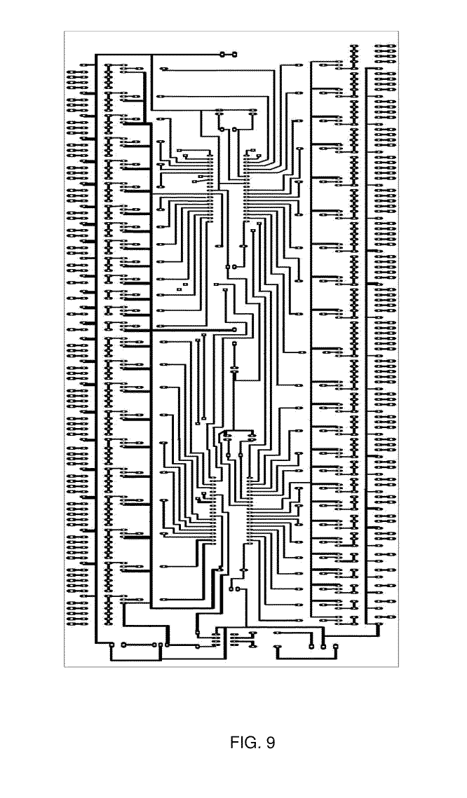

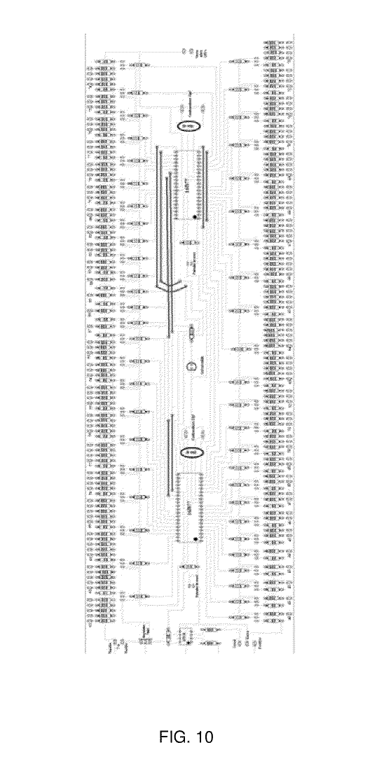

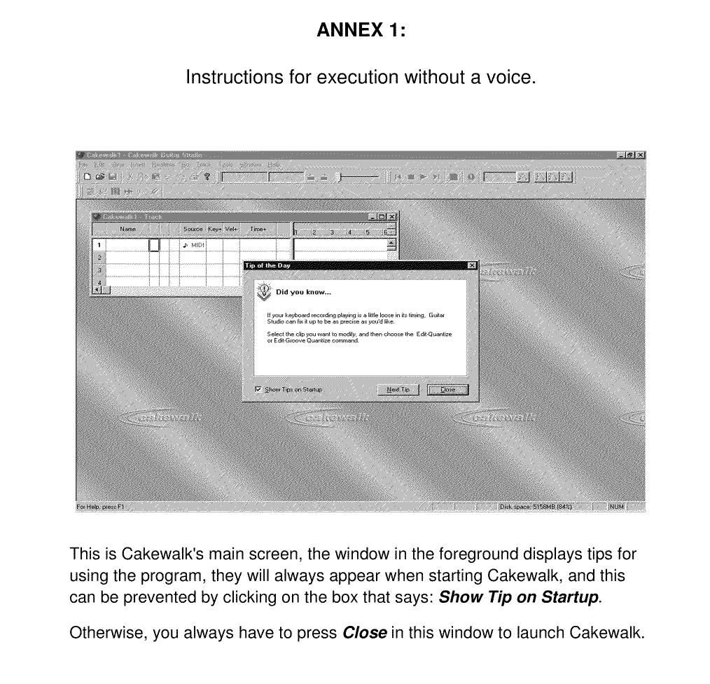

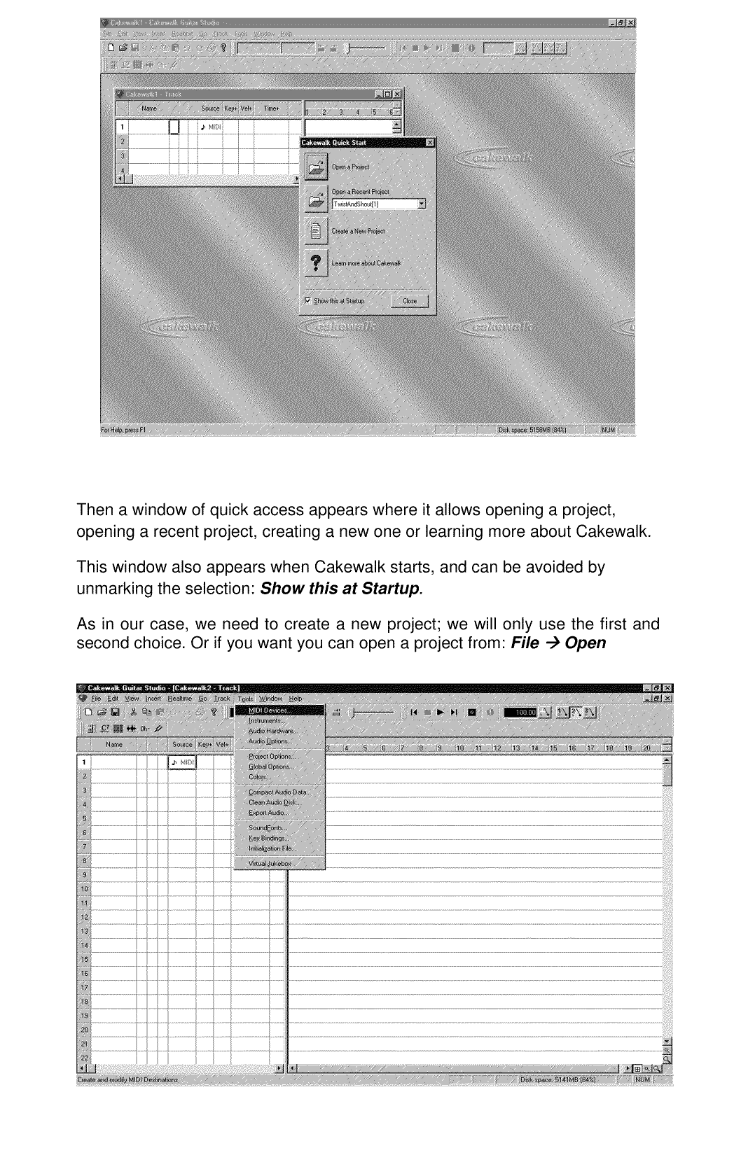

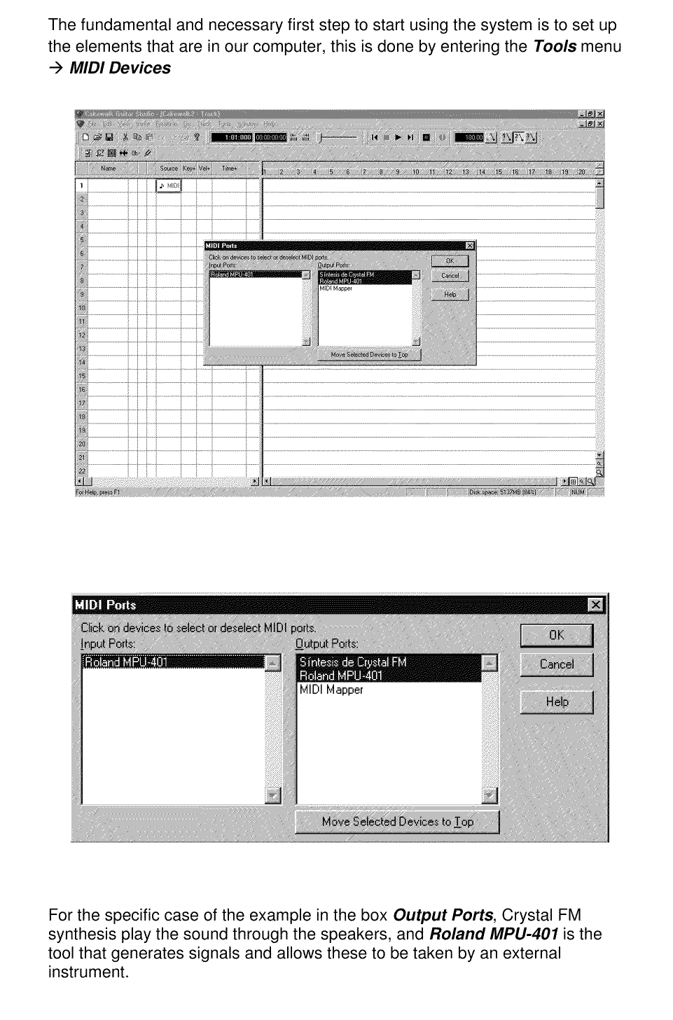

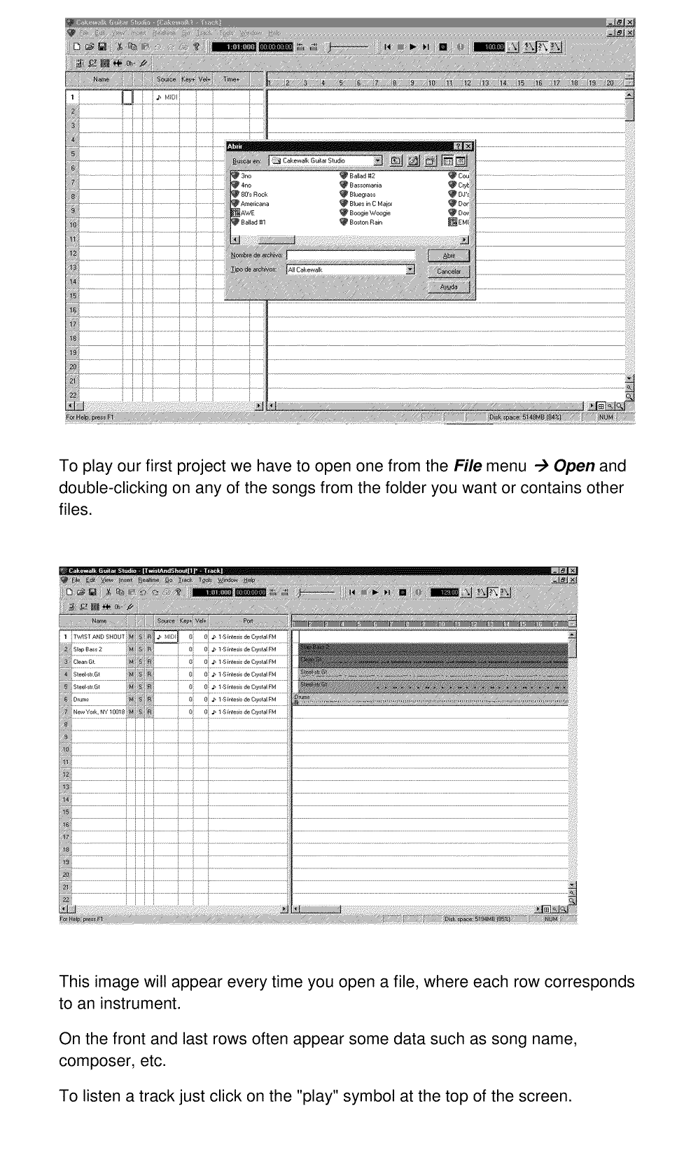

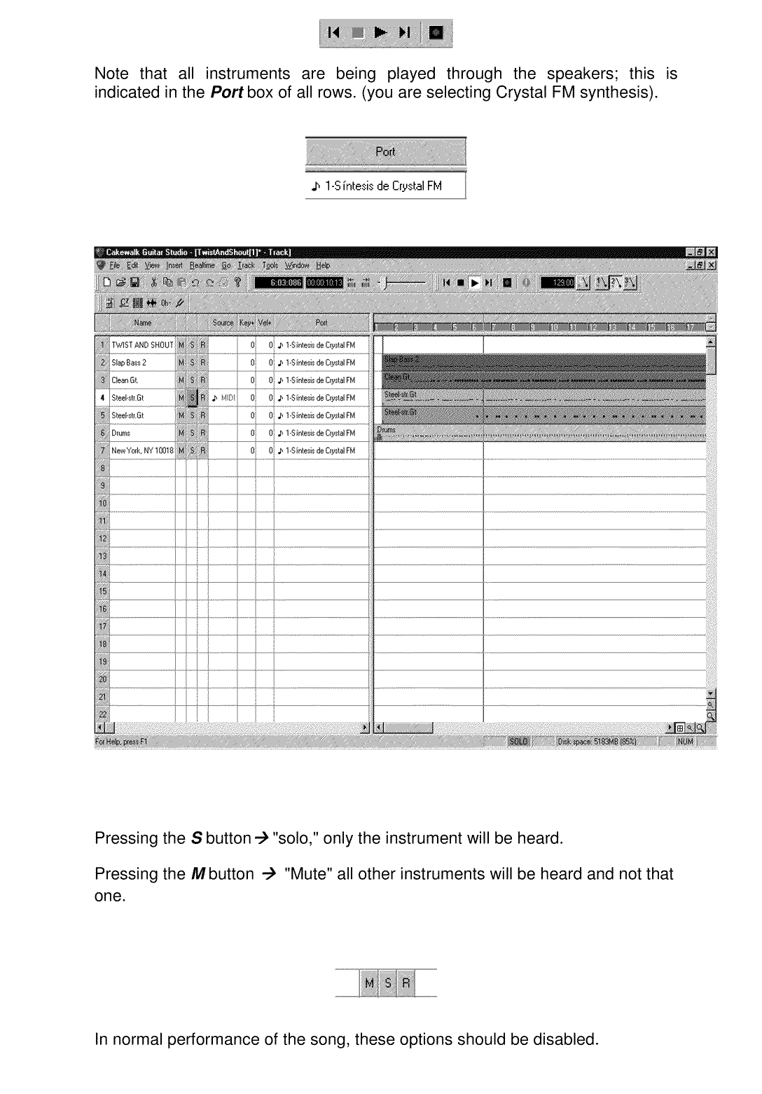

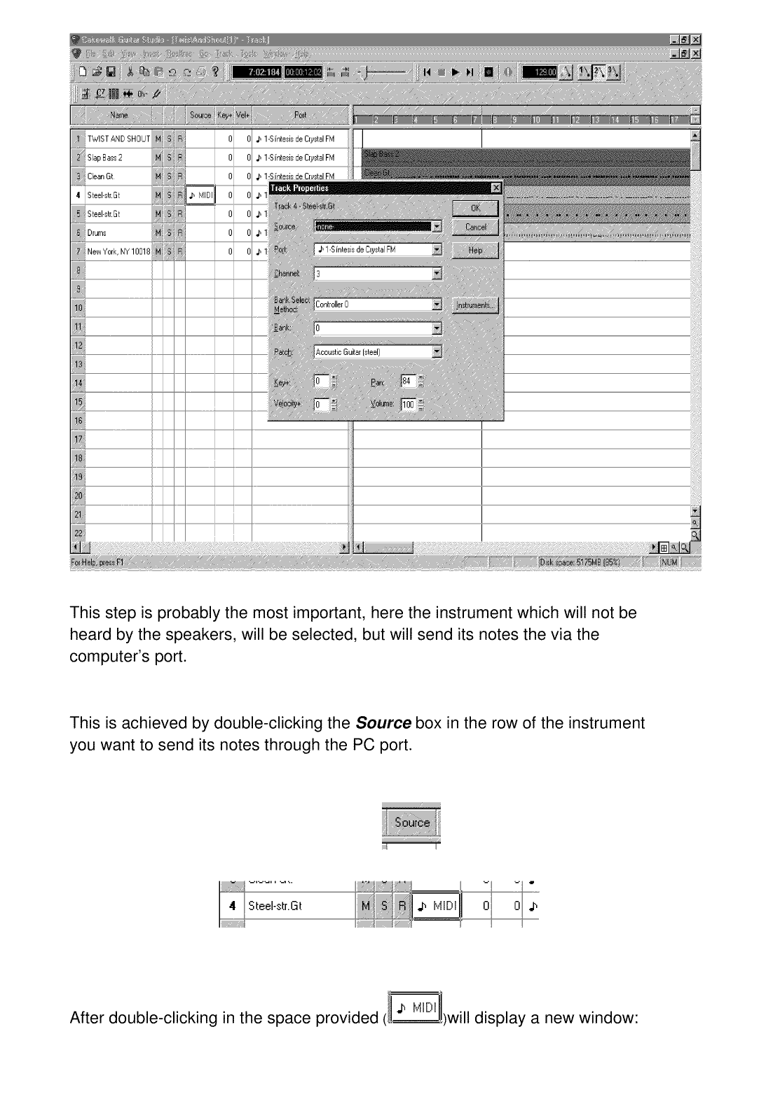

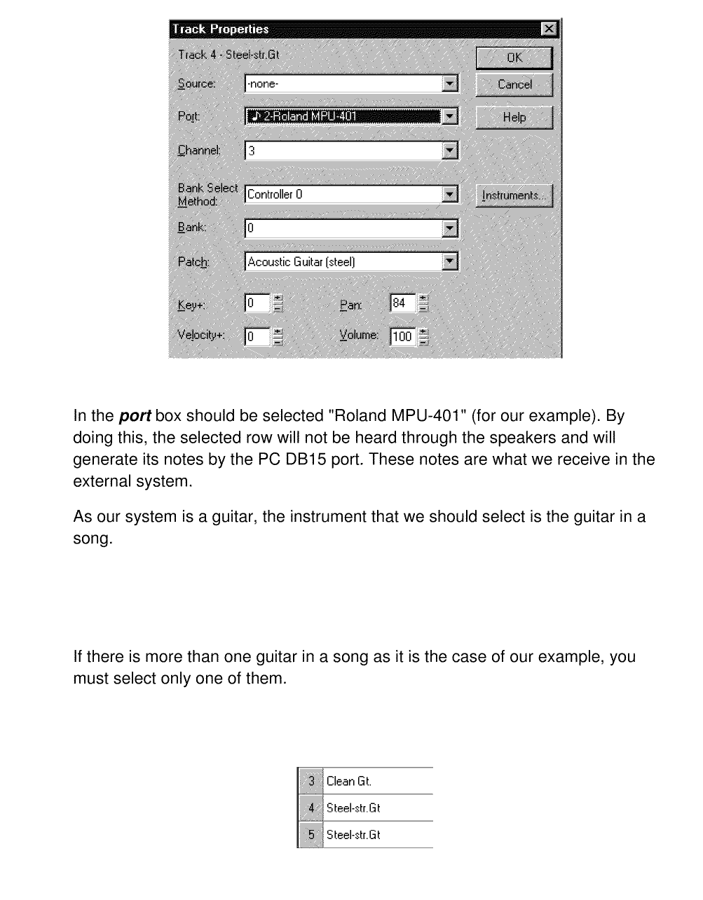

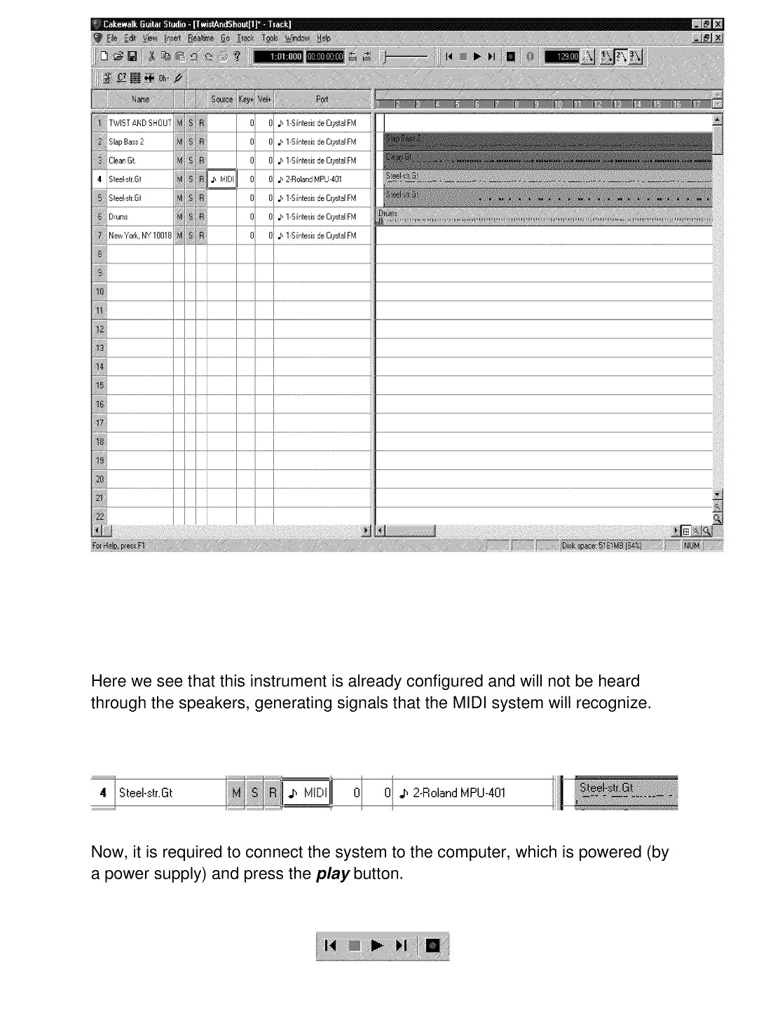

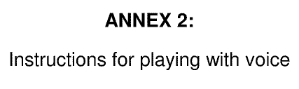

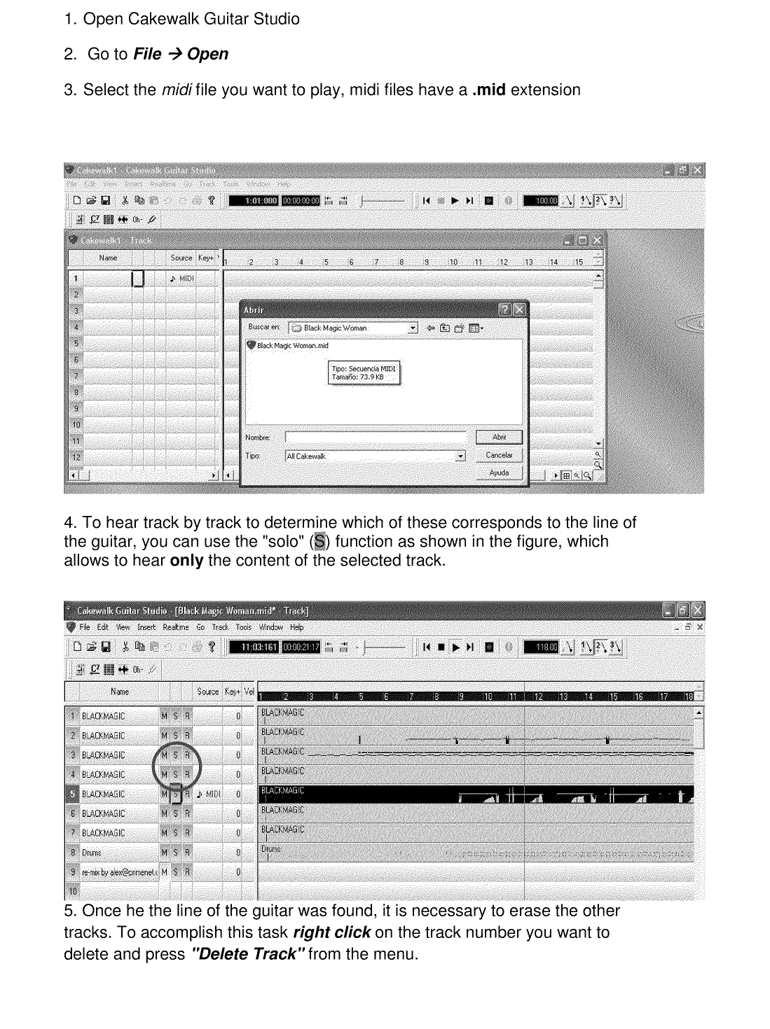

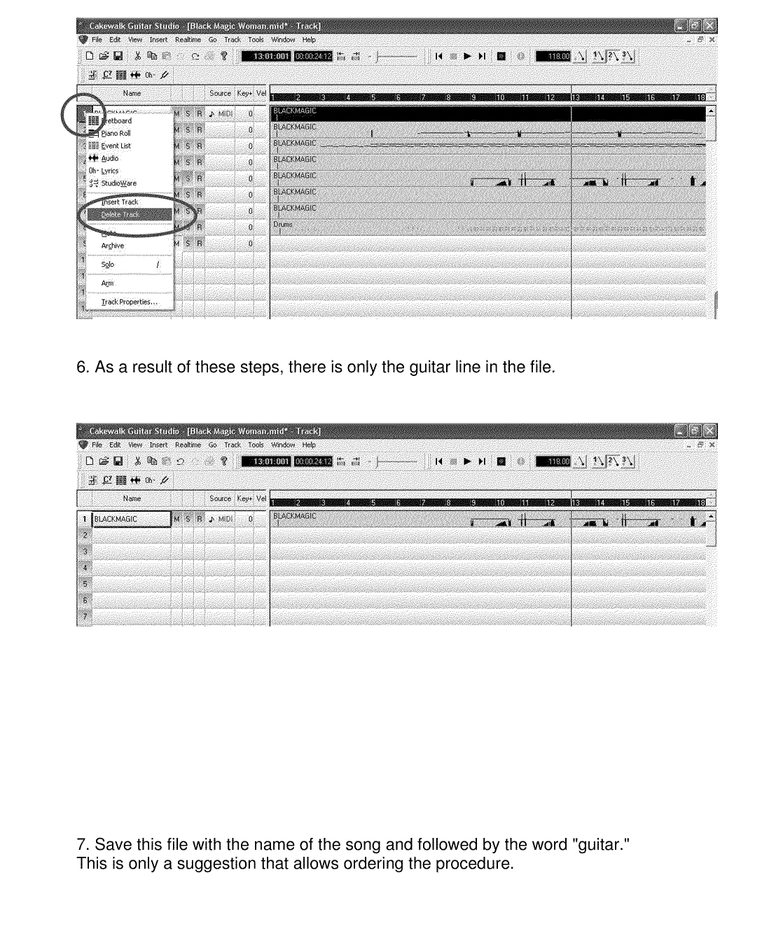

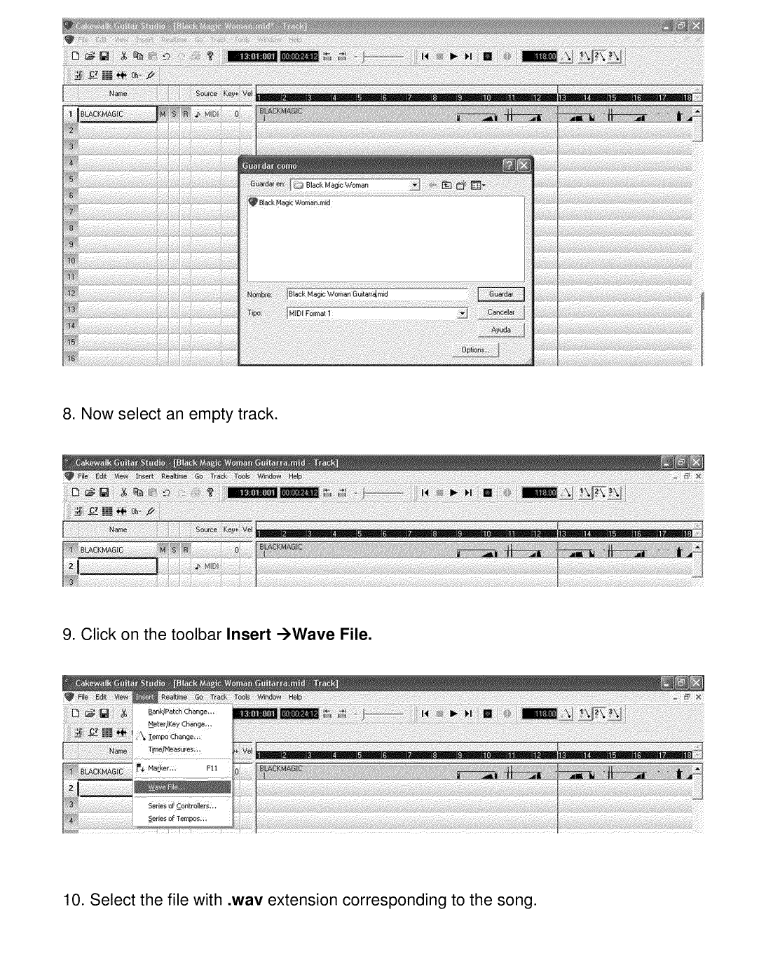

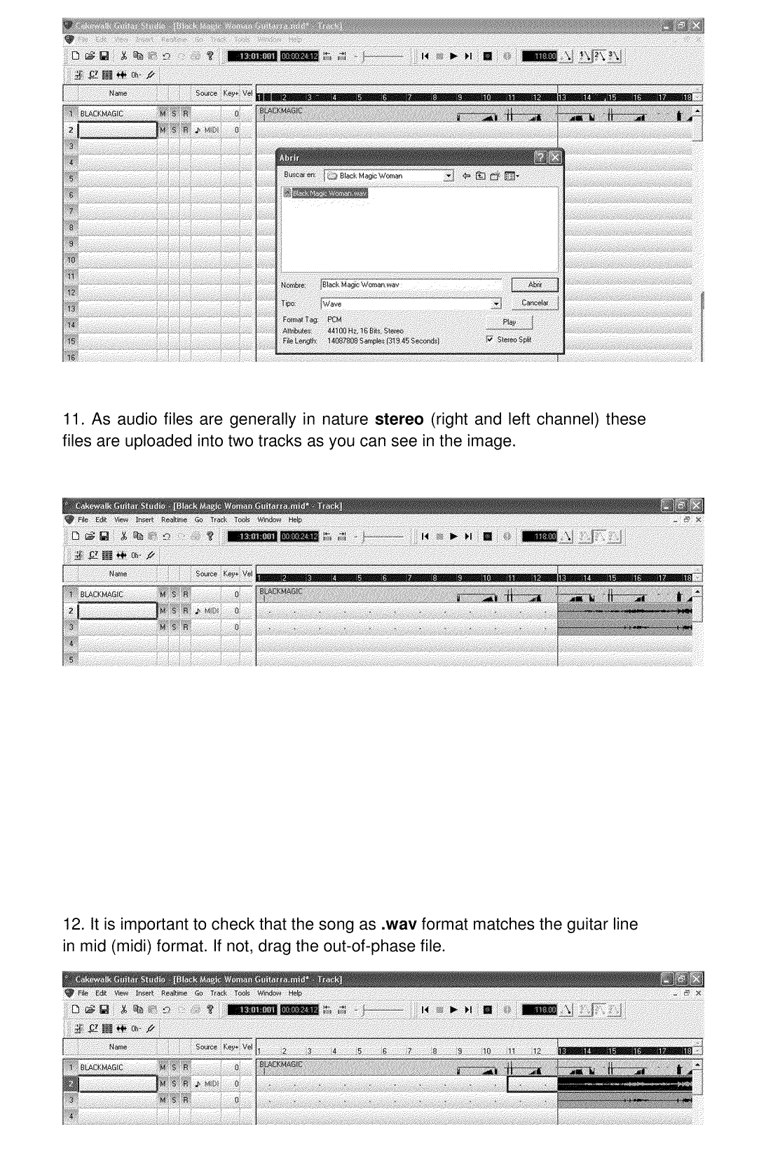

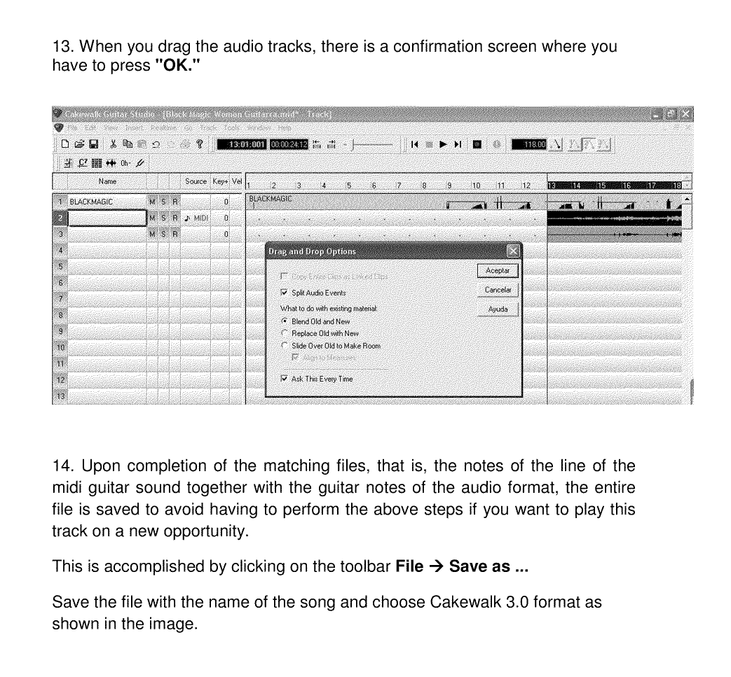

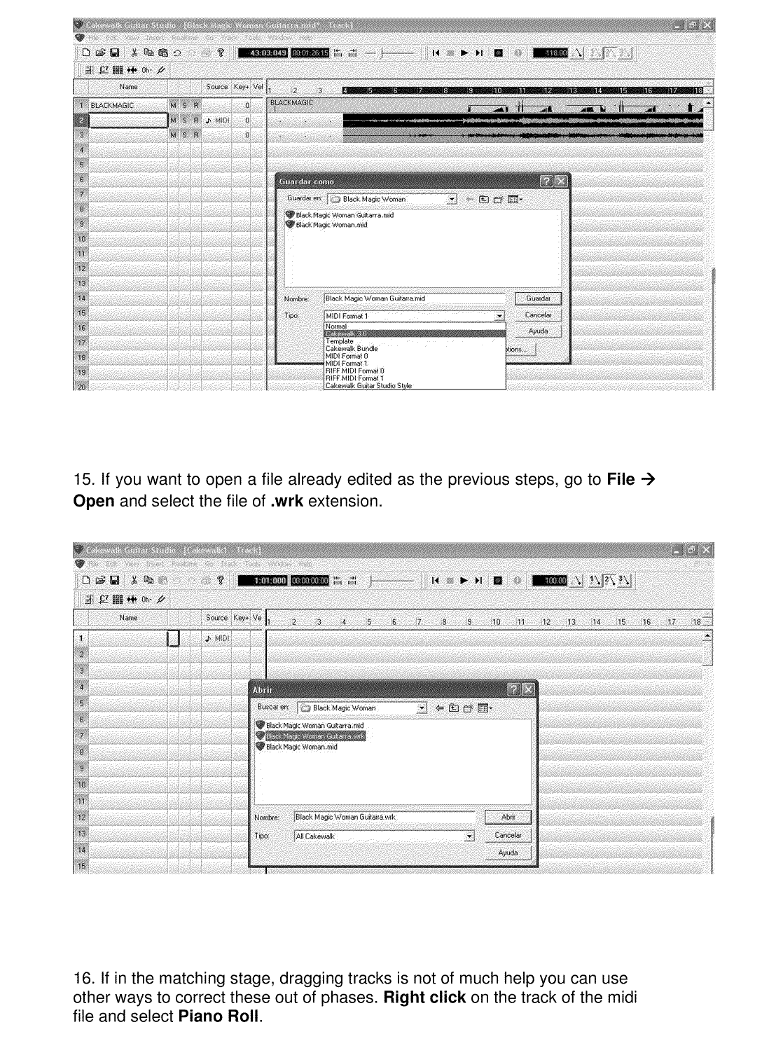

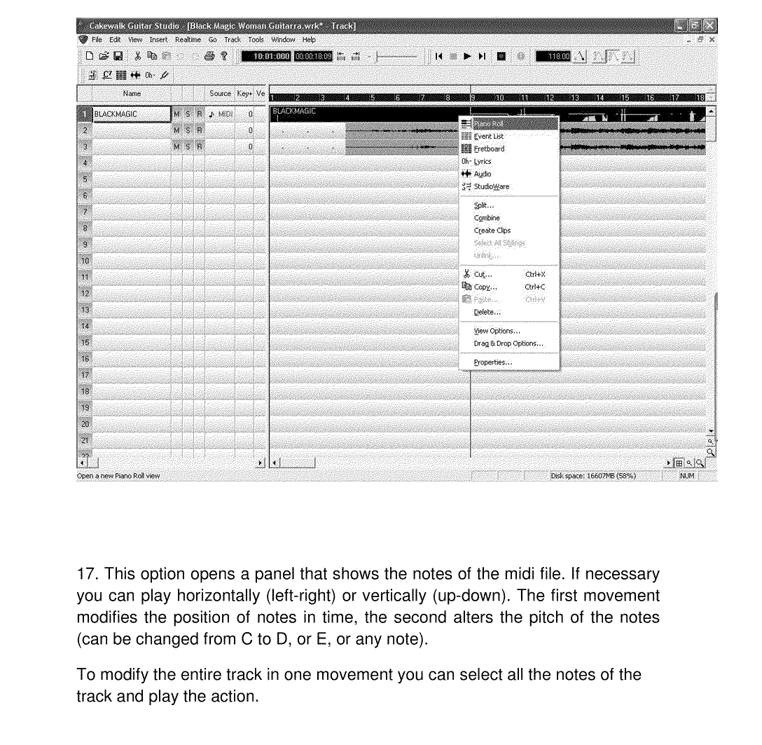

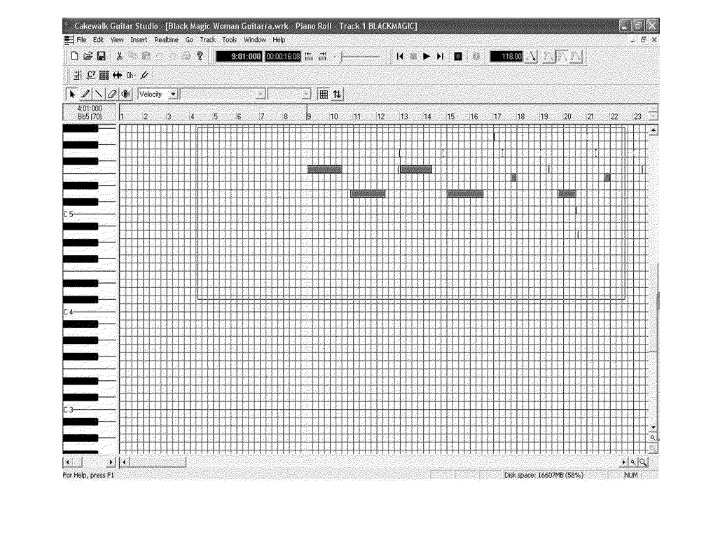

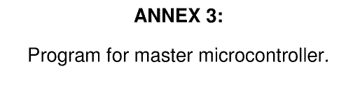

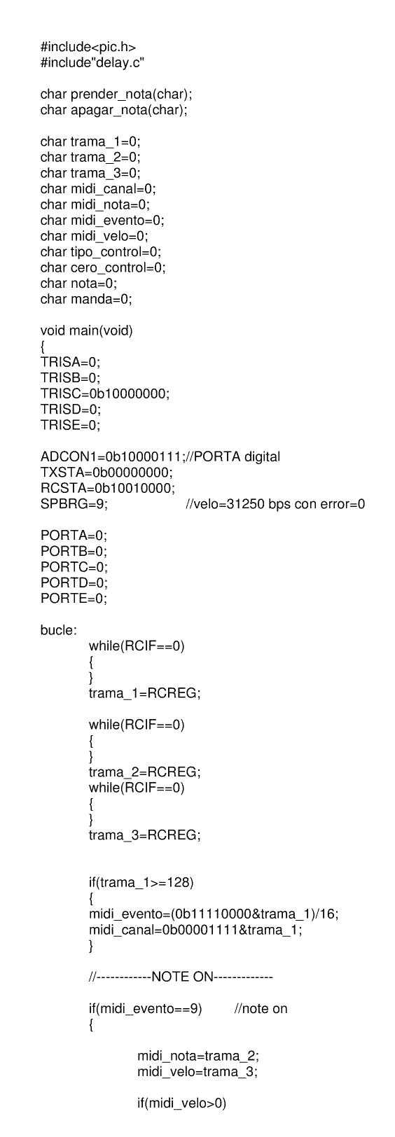

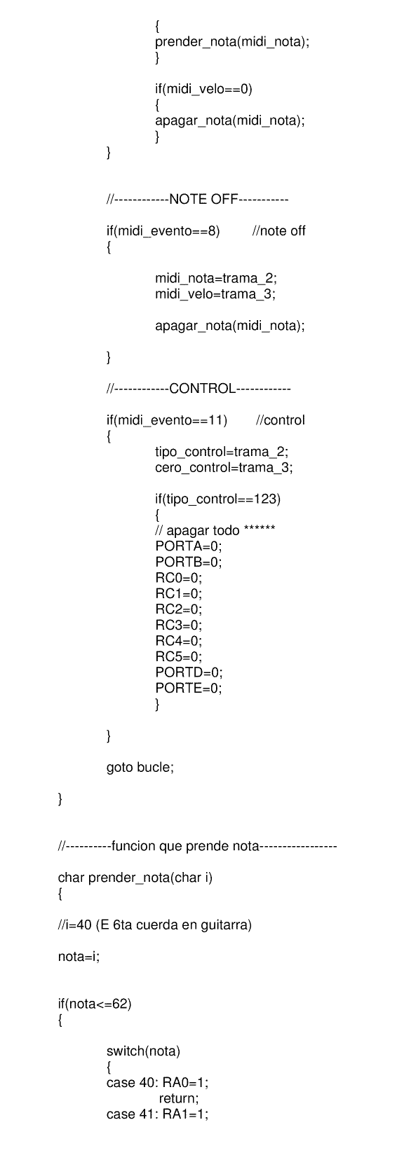

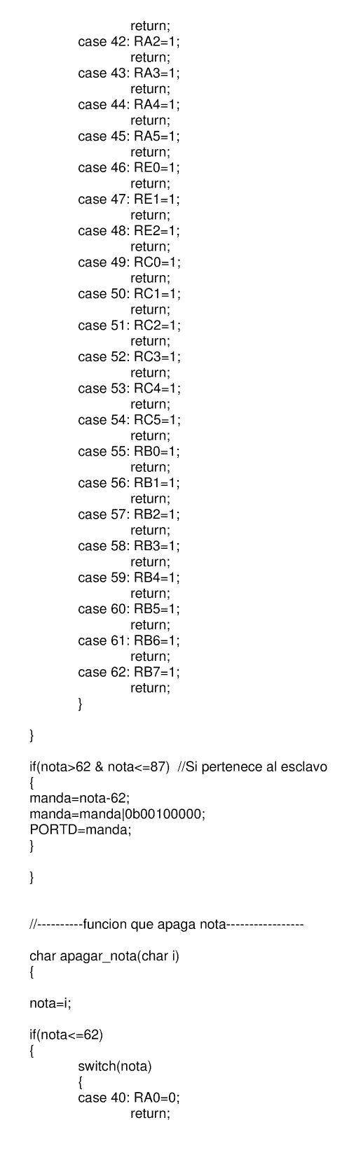

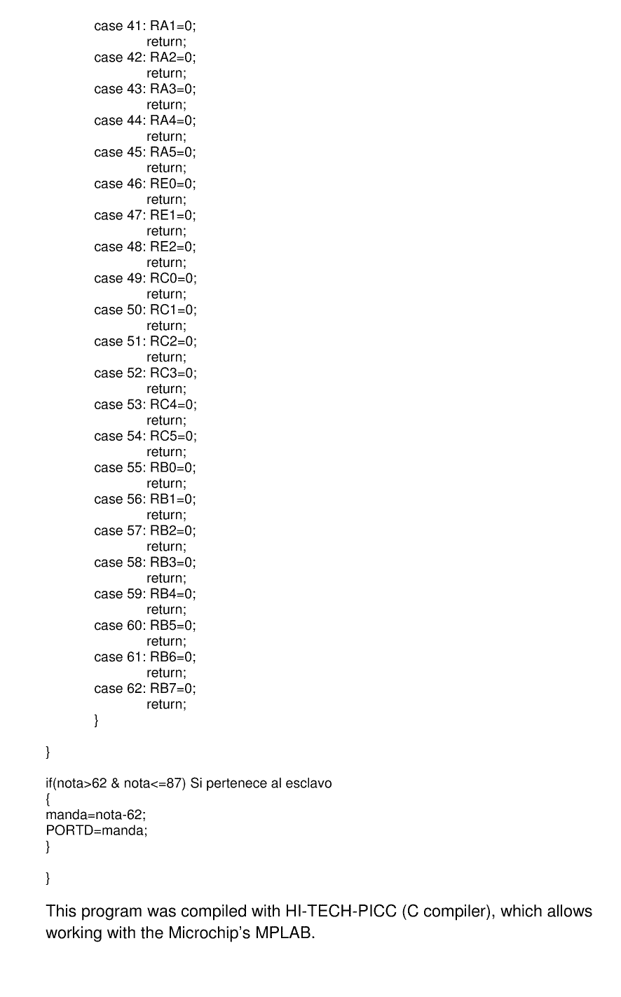

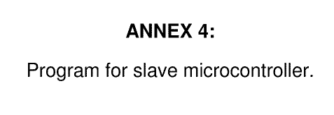

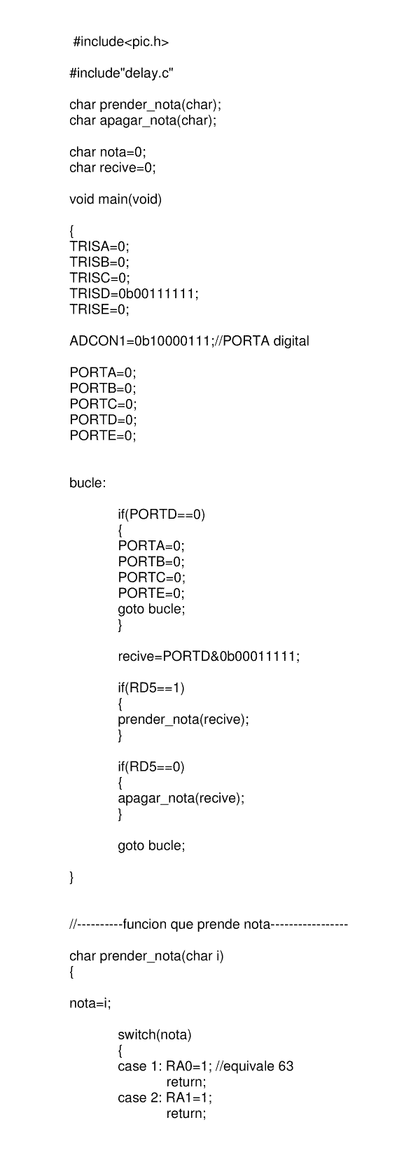

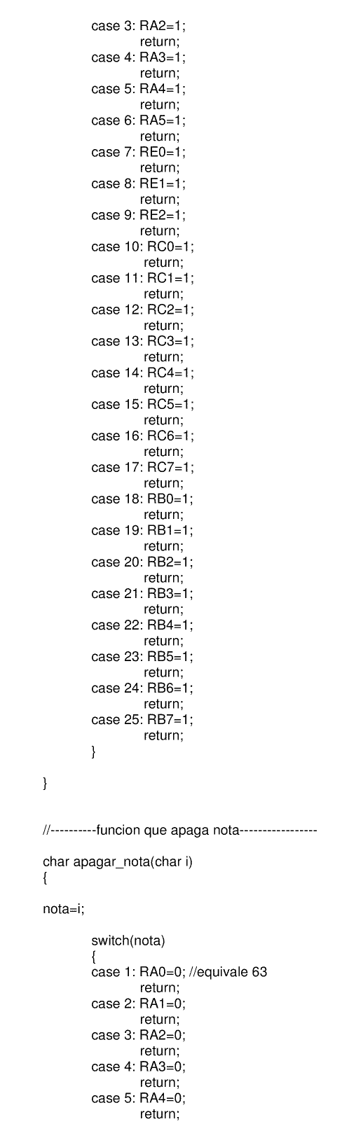

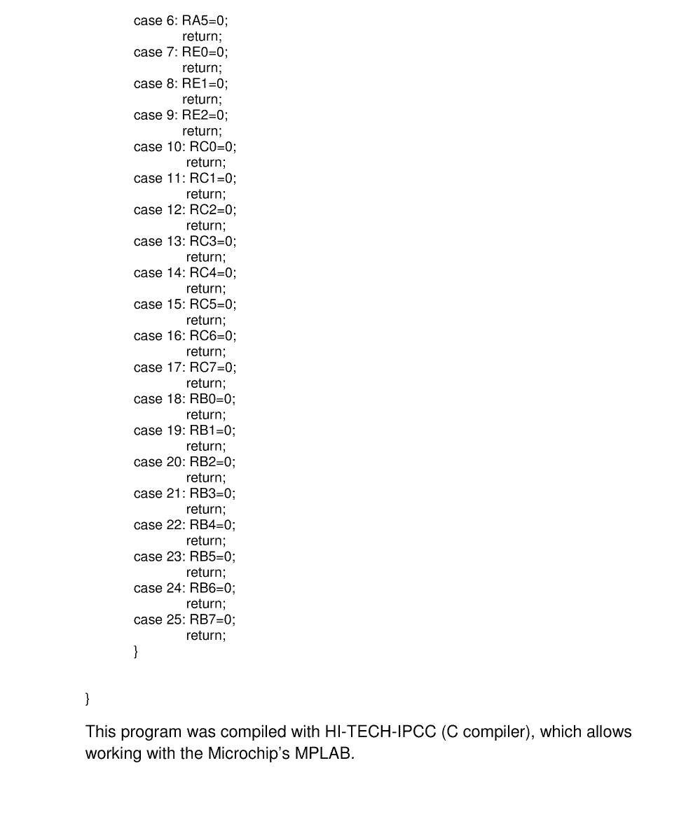

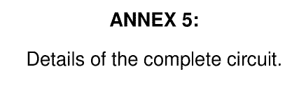

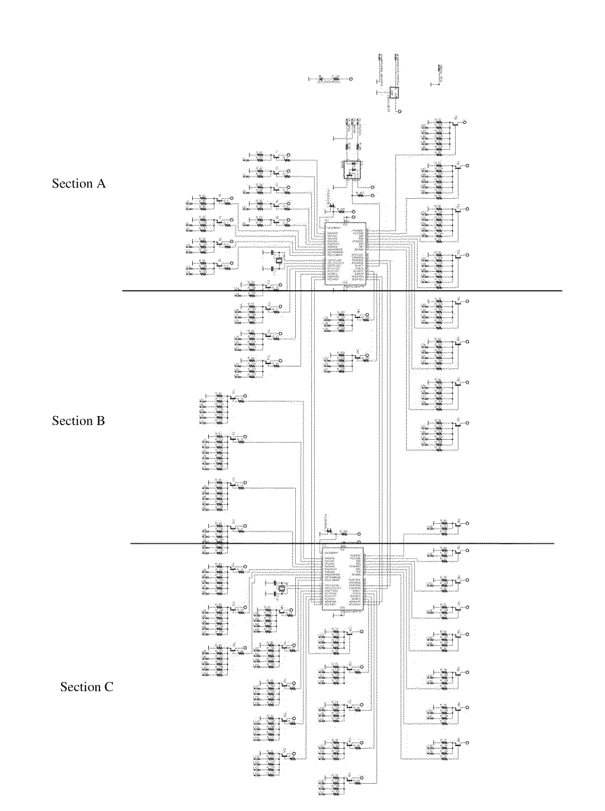

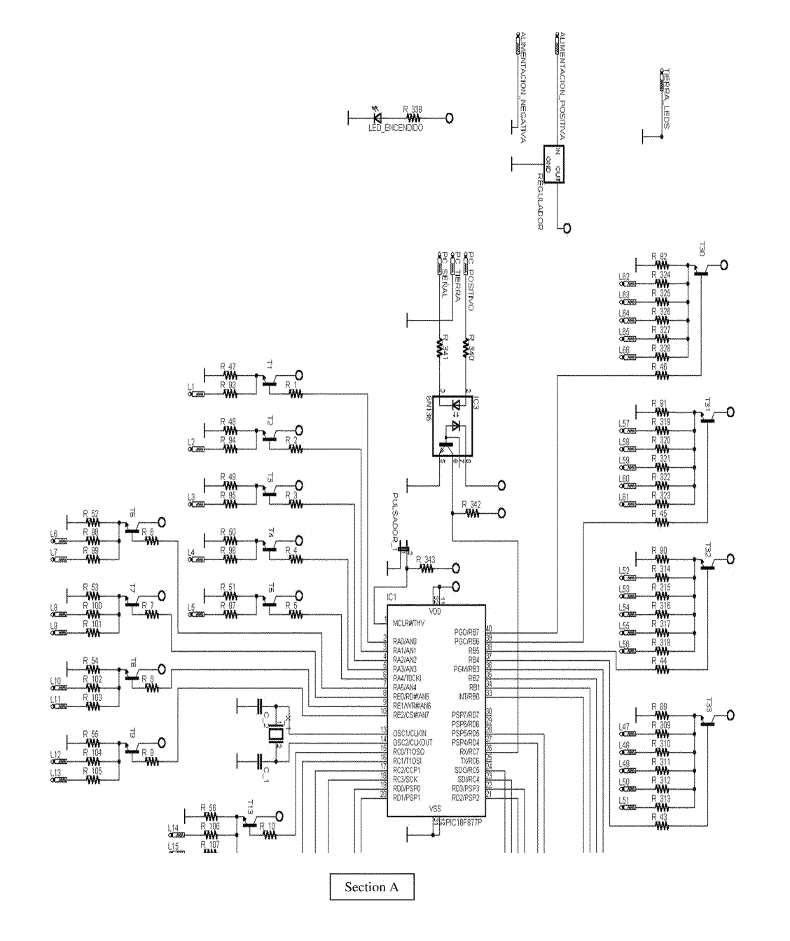

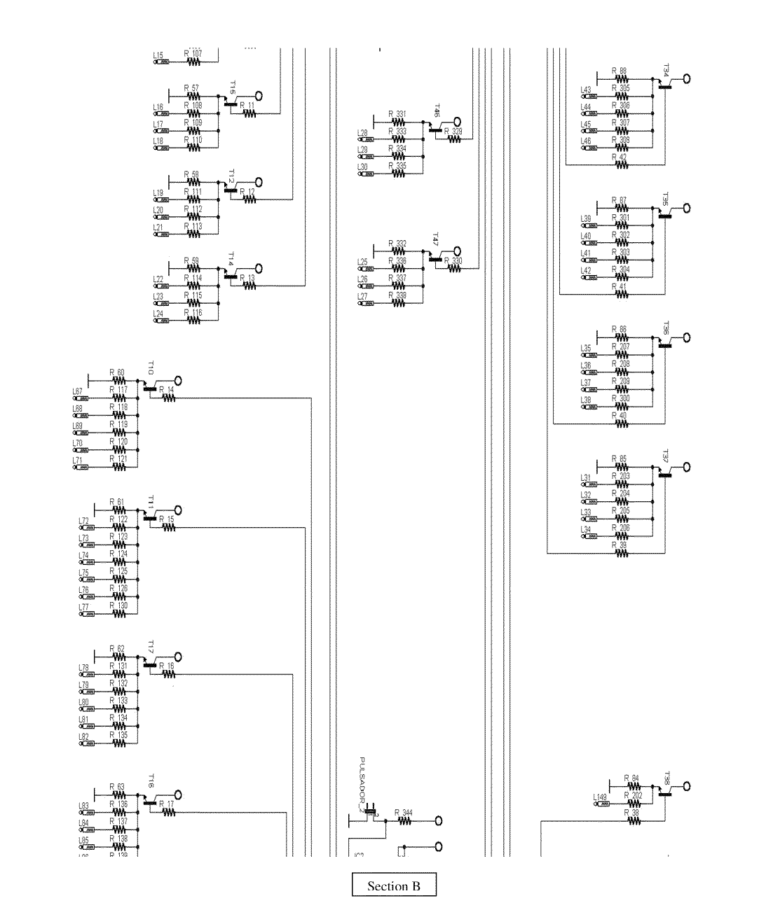

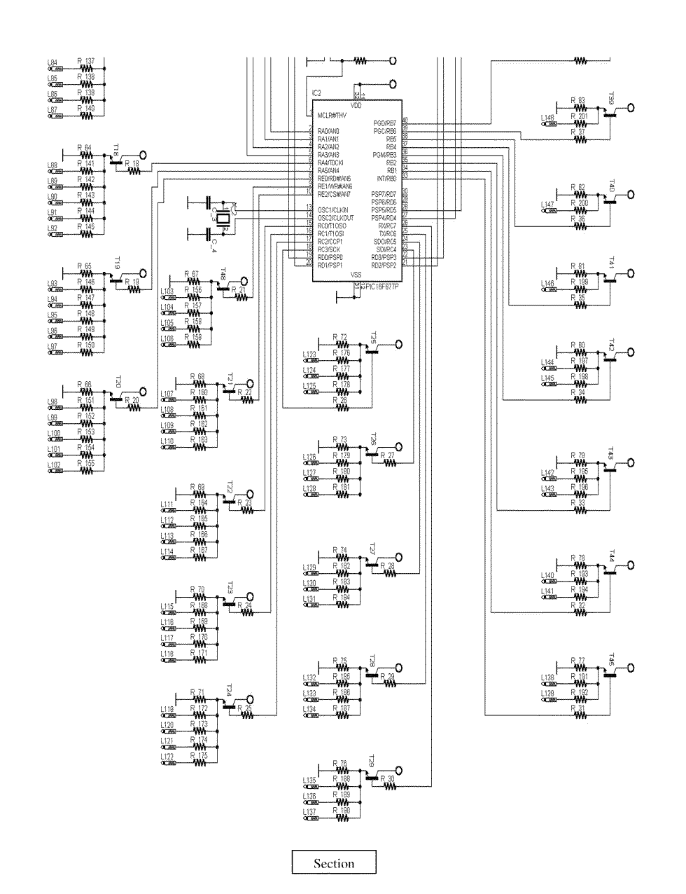

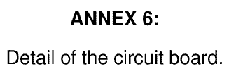

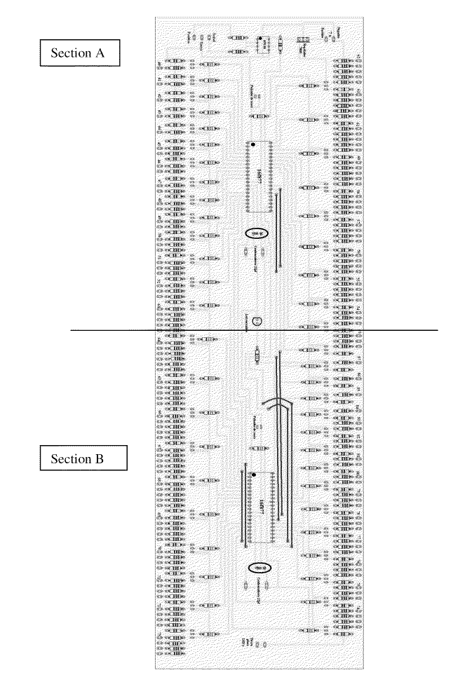

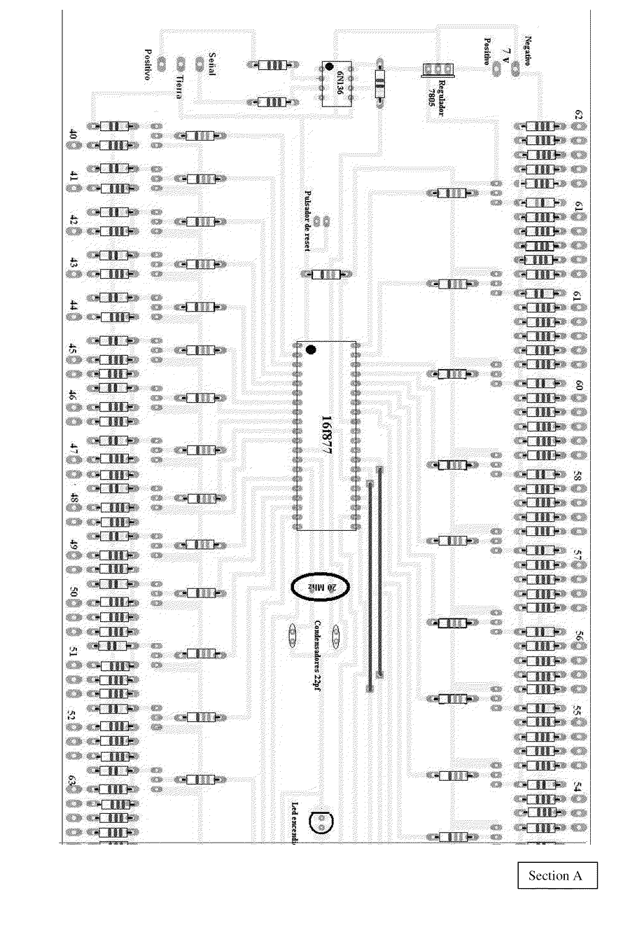

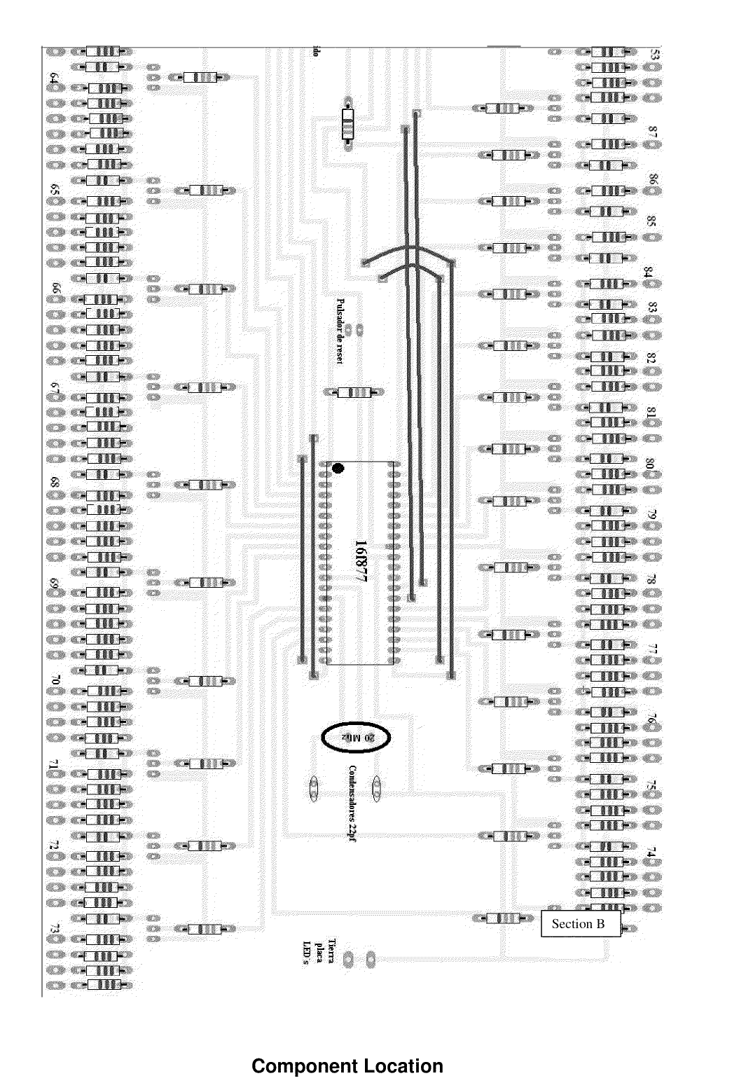

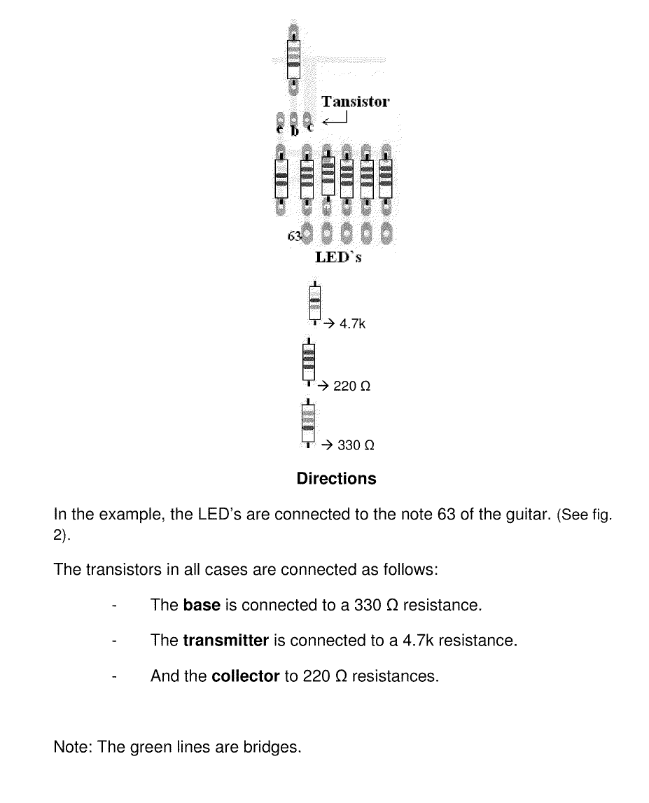

The diagram of the circuit board, ready for assembly of components, is shown in FIG. 9 and the location of these components in FIG. 10. An enlargement of the detail of the components is shown in Annex 6, which includes instructions for installation.

APLSSI may also apply to string instruments with no frets on the neck, such as violin, cello or bass, using micro LEDs very closely distributed on the neck along each string, so, as described to play the APLSSI's prepared instrument, fulfills an identical function.

ANNEXES

Annex 1: Instructions to play without a voice.

Annex 2: Instructions to play with a voice.

Annex 3: Program for master microcontroller.

Annex 4: Program for slave microcontroller.

Annex 5: Details of the complete circuit.

Annex 6: Details of the circuit board.

1-12. (canceled)

13. A method for teaching a person to play music, the method comprising the steps of:
providing a string instrument including a plurality of strings and a visual light signal located near each one of the strings;
entering a musical database into a computer system arranged by a coordination matrix of frets and strings, wherein the musical database includes a plurality of musical pieces, wherein each musical piece includes musical notes;
selecting a musical piece from the musical database;
wherein the system recognizes the musical piece and arranges the musical piece notes to be played by the musical instrument;
wherein the system substitutes the musical notes by the visual light signal; and
wherein the visual light signal illuminates on the exact moment and point where the string needs to be pressed to play the musical note.

14. The method of claim 13, wherein the visual light signal is a Light-Emitting Diode.

15. The method of claim 13, wherein the computer system comprises a main microcontroller and a secondary microcontroller, wherein the main microcontroller decodes PC signals and illuminates the visual light signals corresponding to the musical note being played.

16. The method of claim 15, wherein the main microcontroller and the secondary microcontroller only generate digital information or Musical Instrument Digital Interface.

17. The method according to claim 13, wherein the string instrument is a guitar.

18. The method according to claim 13, wherein the string instrument is an electric guitar.

19. The method according to claim 13, wherein the string instrument is a bass.

20. The method according to claim 13, wherein the string instrument is a Hawaiian guitar.

21. The method according to claim 13, wherein the string instrument is a mandolin.

22. The method according to claim 13, wherein the string instrument is a charango.

23. The method according to claim 13, wherein the string instrument is a sitar.

24. The method according to claim 13, wherein the string instrument is a banjo.

25. The method according to claim 13, wherein the string instrument is a violin.

26. The method according to claim 13, wherein the string instrument is a cello.

27. The method according to claim 13, wherein the string instrument is a double bass.
